(19) United States
(12) Patent Application Publication
(10) Pub. No.: US 2015/0067766 A1
(43) Pub. Date: Mar. 5, 2015

(54) APPLICATION SERVICE MANAGEMENT DEVICE AND APPLICATION SERVICE MANAGEMENT METHOD

(71) Applicant: POWER-ALL NETWORKS LIMITED, Shatin (HK)

(72) Inventor: STEVE LAP WAI HUI, Shatin (HK)

(21) Appl. No.: 14/469,599

(22) Filed: Aug. 27, 2014

(30) Foreign Application Priority Data
Aug. 27, 2013 (CN) 201310376559X

(51) Int. Cl. H04L 29/06

(52) U.S. Cl. CPC H04L 63/08; H04L 63/20
USPC 726/1; 726/27

(57) ABSTRACT

An application service management method includes: assigning permission of the application service items comprised in an application cluster to the users of the user group. Verifying an identity of the user in response to a login operation of the user via a terminal device, and determining the user group that the user belonged to, the corresponding application cluster, and application service items that the user with the permission to use, after verifying the user is a legal user. Requesting an application service provider to execute an application service item when one permitted user of the user group generates an execution operation on the application service item. In addition, obtaining an application execution interface from the application service provider and displaying the obtained application execution interface on the terminal device of the user.

### CROSS-REFERENCE TO RELATED APPLICATIONS

This application claims priority to Chinese Patent Application No. 201310376559.X filed on Aug. 27, 2013 in the China Intellectual Property Office, the contents of which are incorporated by reference herein.

### FIELD

The present disclosure relates to management devices, and particularly to an application service management device and a method thereof.

### BACKGROUND

Electronic devices, such as mobile phones and tablet computers, can execute a number of functions by executing corresponding applications. Usually, when the electronic devices needs to execute a function of application, the application should installed in the electronic devices firstly.

### BRIEF DESCRIPTION OF THE DRAWINGS

Implementations of the present technology will now be described, by way of example only, with reference to the attached figures.

FIG. 1 is a block diagram of an application service management device.

FIG. 2 is a block diagram of an embodiment of an application service management system running in the application service management device.

FIG. 3 is a diagrammatic view of a management interface provided by the application service management system.

FIG. 4 is a flowchart of an embodiment of an application service register management method of application service management method.

FIG. 5 is a flowchart of an embodiment of an application assignment and execution method of an application service management method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected.

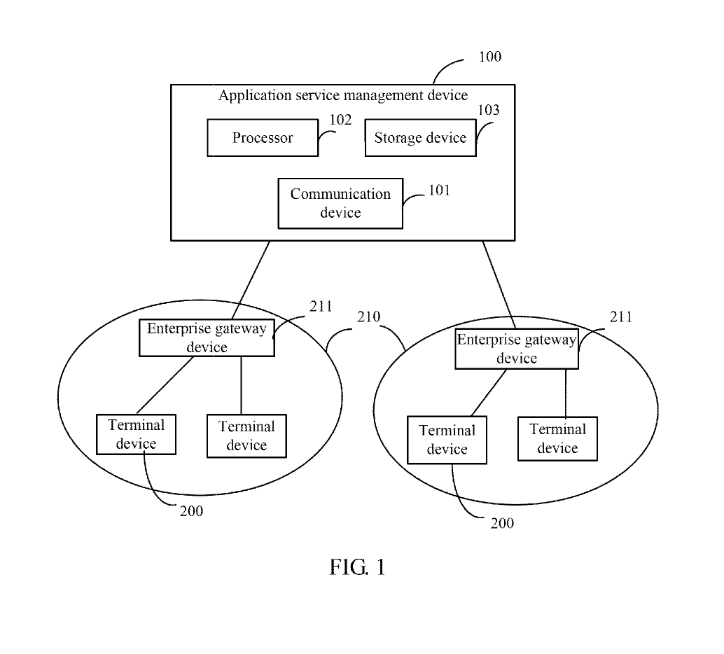

Referring to FIG. 1, an application service management device 100 includes a communication device or unit 101. The application service management device 100 is communicably connected to the at least one terminal device 200 via the communication unit 101, either directly or via a telecommunications network such as a local area network, a wireless network, or the Internet. Each of the at least one terminal device 200 is a device used by a user of a user group 210, the terminal device 200 can be a mobile phone, a tablet computer, a portable computer, a desktop computer, set-top box, in-vehicle computer, gaming console, and the like. The user group 210 can be an enterprise, a school, or other organizations. The application service management device 100 can be a single server or a server group. The communication unit 101 can be a wireless communication module (such as a telecommunication network module), or a wired communication module.

In one embodiment, the application service management device 100 further includes a processor 102 and a storage device 103, and may include other computer components, communications interfaces, human interface devices, and so forth.

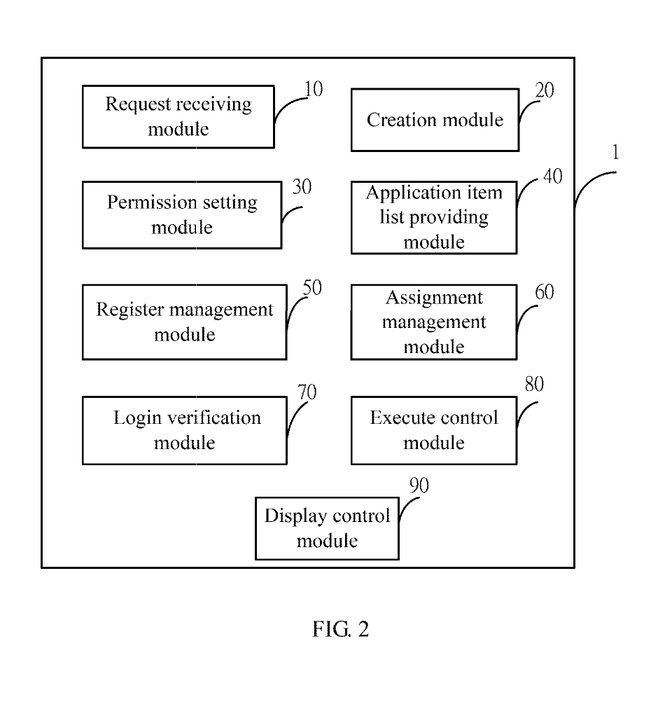

Referring to FIG. 2, an application service management system 1 is stored in the storage device 103 and executed by the processor 102. The application service management system 1 includes a request receiving module 10, a creation module 20, a permission setting module 30, an application service item list providing module 40, a register management module 50, an assignment management module 60, a login verification module 70, an execute control module 80, and a display control module 90. The modules of the application service management system 1 can be a collection of software instructions stored in the storage device 103 and executed by the processor 102, or can include functionality represented as hardware or integrated circuits, or as software and hardware combinations, such as a special-purpose processor or a general-purpose processor with special-purpose firmware. In one embodiment, the processor 102 can be a central processing unit, a digital signal processor, or a single chip, for example. In one embodiment, the storage device 103 can be an internal storage system, such as a flash memory, a random access memory (RAM) for temporary storage of information, and/or a read-only memory (ROM) for permanent storage of information. The storage device 103 can also be a storage system, such as a hard disk, a storage card, or a data storage medium. The storage device 103 can include volatile and/or non-volatile storage devices. In at least one embodiment, the storage device 103 can include two or more storage devices such that one storage device is a memory and the other storage device is a hard drive. Additionally, one or more of the storage devices 102 can be located either entirely or partially external relative to the application service management device 100.

The request receiving module 10 is used to receive a creation request for applying application service from a user group 210, the creation request includes an identity of the user group 210. The identity of the user group 210 can be specified as an enterprise registration number, a unique group identifier, or the like. In detail, a user of the user group 210 can access a webpage provided by the application service management device 100, and input information including the identity of the user group 210 to submit the creation request.

The creation module 20 is used to create an application cluster associated with the identity of the user group 210 and assign a group account for the user group 210 when receiving the request for applying application service. The group account is associated with the application cluster and the identity of the user group 210.

The permission setting module 30 is used to generate an administrator account according to the group account, the administrator account includes information of the group account. Therefore, the user that logins via the administrator account is an administrator. The permission setting module 30 further sets permission of the administrator, for example, the permission setting module 30 sets the permission to add one or more application service items, delete one or more application service items for the administrator as described below.

The application service item list providing module 40 is used to provide at least one application service item list which includes a number of selectable application service items, such as games, office software, system software, or other software or firmware packages. In detail, the application service item list providing module 40 searches application services provided by each application service provider, and produces the application service item list according to the searched application services. In another embodiment, the application service item list providing module 40 searches whether there is a new application service item is issued by one of the application service providers or whether there is one application service item has updated version at intervals (such as, every day). The application service item list providing module 40 further updates the application service item list when there is a new application service is issued by one of the application service providers or there is one application service has a updated version. In detail, the application service item list providing module 40 compares a version of each application service item of the application service item list to a version of the corresponding application service item issued by the corresponding application service provider, thus to determine whether there is one application service item has updated version. The application service item list providing module 40 compares the application service items of the application service item list to the application service items issued by the corresponding application service provider to determine whether one of the application service providers has issued a new application service item.

The register management module 50 is used to produce a register request including information of a group account of a user group 210 and an application service item in response to an operation of selecting the application service item from the application service item list by the administrator of the user group 210. The register management module 50 can further send the register request to the application service provider providing the selected application service item to register in the application service provider, and can add the selected application service item to the application cluster if registered in the application service provider successfully. Therefore, the user of the user group 210 can use the corresponding application service item via the application cluster. In details, the register management module 50 sends the register request including information of the group account to the application service provider providing the selected application service to register in the application service provider as follows: when the register management module 50 sends the register request to the application service provider, the application service provider assigns the permission to use the selected application service for the user group 210 corresponding to the group account in response to the register request.

In the embodiment, each application service item has a number of functions, such as, an email application has many functions, such as sending email, receiving email. The permission to use the selected application service includes permitted functions of the selected application service item and a duration of using the application service.

In the embodiment, the register management module 50 is further used to produce a cancelling request for cancelling one application service item in response to an operation of cancelling the application service item on the application service item list. The register management module 50 then sends the cancelling request to the corresponding application service provider to delete the information of the group account from the corresponding application service provider, and deletes the application service item from the application cluster. In the embodiment, the cancelling request also includes information of the group account and the application service item, the application service provider disables the permission to use the application service item for the group account according to the information included in the cancelling request.

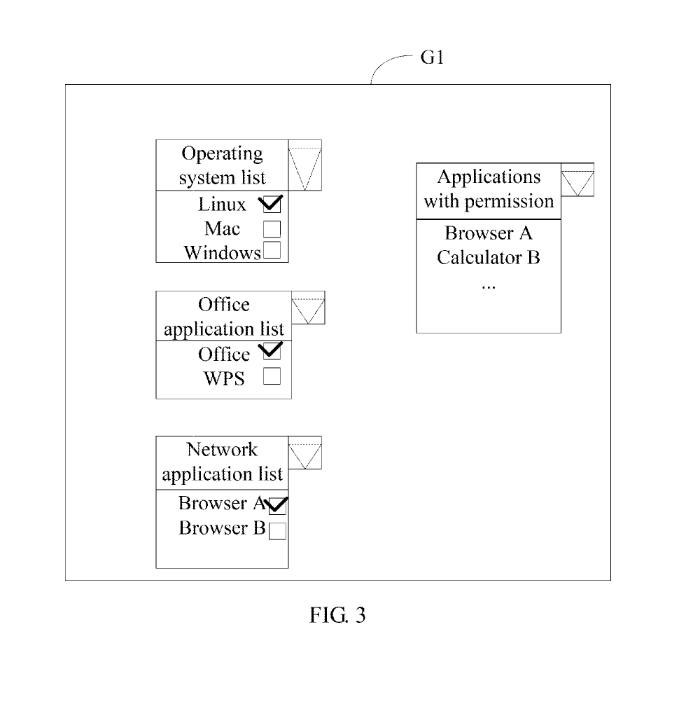

Referring to FIG. 3, an application cluster management interface G1 is shown. After the creation module 20 creates the application cluster for a user group 210, the user of the user group 210 can log in the application cluster management interface G1 and manage or use the application service item via the application cluster management interface G1.

In the embodiment, the application cluster includes a number application service item modules, which include but not limited to, an office application module, an operating system module, a network application module, or the like. Based on the modules of the application cluster, the user, such as the administrator of the user group 210 can add, delete, change the application service items corresponding to the modules of the application cluster.

As shown in FIG. 3, in the embodiment, the application service item list providing module 40 provides different application service item lists according to each application service item module of the application cluster. For example, the application service item list providing module 40 provides an office application list corresponding to the office application module, an operating system list corresponding to the operating system module, and a network application list corresponding to the network application module. The administrator of the user group 210 can produce the register request, the cancelling request by operating the application service item of the corresponding application service item list.

In the embodiment, each application service item can be an application or an operating system software.

In the embodiment, the creation module 20 is further used to create at least one normal user account in responses to a creation operation of the administrator. In detail, the creation module 20 creates the normal user account based on the group account of the user group that the administrator belongs to, the normal user account includes the information of the group account. The user logs in via the normal user account which belongs to the corresponding user group 210, namely the user group 210 corresponding to the group account which is included in the normal user account. As described above, the administrator account includes a corresponding group account, in the embodiment, the creation module 20 obtains the information of the group account from the administrator account, and then creates the normal user account based on the obtained group account.

The assignment management module 60 is used to assign permission of the application service items included in the application cluster to the users of the user group 210, thus to set the permission for each user of the user group 210. For example, if the application cluster includes application service items A, B, C, and D, the assignment management module 60 can assign the permission to use the application service items A, B, C to one user, and assign the permission to use the application service items A, B to another user. Therefore, the assignment management module 60 assigns the permission to use which application service items for each user including the administrator and the normal user.

The login verification module 70 is used to verify the identity of the user in response to a login operation of the user. In the embodiment, the login verification module 70 verifies the identity of the user via a user account and password input by the user. The user account can be the administrator account, the normal user account, or some other user account. When the login verification module 70 verifies the user is a legal user, the login verification module 70 further determines the user group 210 that the user belongs to and the corresponding application cluster, and determines the application service items that the user is permitted to use.

The execute control module 80 is used to request the application service provider to execute an application service item when the user which is permitted to use the application service item generates an execution operation on the application service item. In detail, when the user of the user group 210 logs in the application cluster management interface G1 via the terminal device 200, the user can double click an icon of a permitted application service item to generate the execution operation.

The display control module 90 is used to obtain an application execution interface from the application service provider and then displays the obtained application execution interface on the terminal device 200.

In the embodiment, the assignment management module 60 further disables the user to use an application service item when the permission to use the application service item for the user is deleted.

The display control module 90 further displays all of application service items that the user has the permission to use on the application cluster management interface G1 when the user logs in the application cluster management interface G1, and displays corresponding description about the corresponding application service item in response to user operation.

In the embodiment, the loG1n verification module 70 determines the user group 210 that the user belongs to according to the user account when the user logs in via the user account, and provides the corresponding application cluster interface G1 to the user. In the embodiment, the administrator and the normal user can log in the application cluster interface G1 via corresponding user account and manage or use the corresponding application service items via the terminal device 200. Of course, when different users log in the application cluster interface G1 via different user account, the content provided by the application cluster interface G1 is different. For example, when the user account logs in the application cluster interface G1 is the administrator, the application cluster interface G1 includes the at least one application service item list provided for the administrator to reG1ster or cancel one or more application service items according to the at least one application service item list.

In the embodiment, the application cluster interface G1 is corresponded to an address, such as a file transfer protocol (FTP) file address, a website address, or the like. The user can input the address of the application cluster interface G1 to enter a loG1n interface of the application cluster interface G1, the user then can input the user account and the password to log in the application cluster interface G1, and then execute the above functions after logging in the application cluster interface G1.

In the embodiment, as shown in FIG. 2, each user group 210 further includes an enterprise gateway device 211. All of the terminal devices 200 of one user group 210 are connected to the corresponding enterprise gateway device 211, and then connected to the application service management device 100 via the enterprise gateway device 211.

In the embodiment, the creation request received by the request receiving module 10 further includes an enterprise gateway address, the creation module 20 further associates the enterprise gateway address with the group account and the identity of the user group 210. The login verification module 70 further obtains the enterprise gateway address when the user logs in the application cluster interface G1, and further verifies the identity of the user according to the enterprise gateway address. In details, the login verification module 70 obtains the group account from the user account and the enterprise gateway address when the user logs in via the user account, and judges whether the enterprise gateway address is corresponded to the group account. The login verification module 70 verifies the user is a legal user when determining the enterprise gateway address is corresponded to the group account.

In the embodiment, an application service management method includes an application service register management method and an application assignment and execution method.

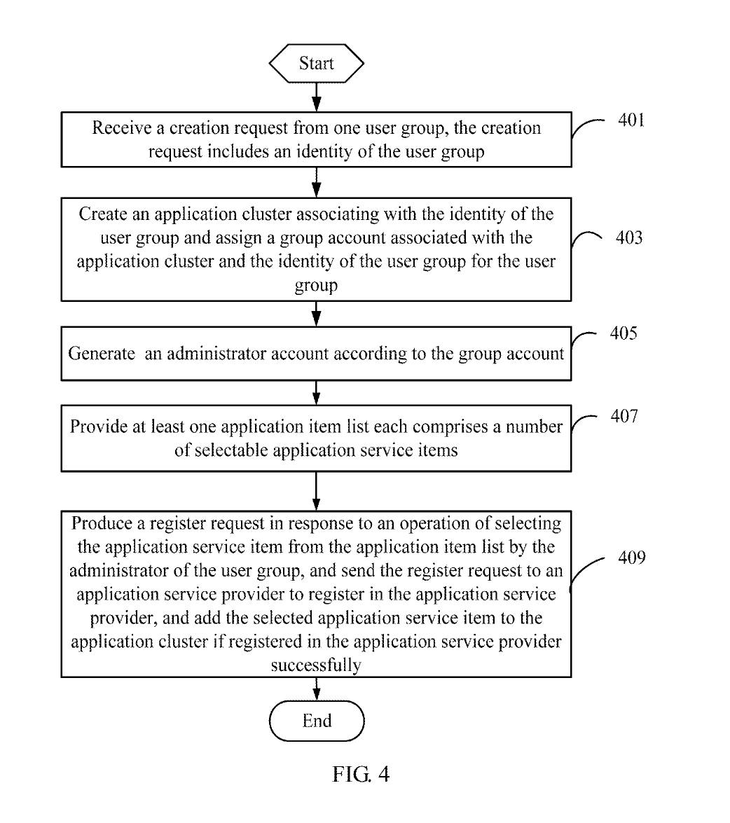

FIG. 4 illustrates a flowchart of the application service register management method included in the application service management method.

In block 401, a request receiving module receives a creation request for applying application service from a user group. The creation request includes an identity of the user group.

In block 403, a creation module creates an application cluster associating with the identity of the user group and assign a group account for the user group when receiving the request for applying application service. The group account is associated with the application cluster and the identity of the user group.

In block 405, a permission setting module generates an administrator account according to the group account. The administrator account includes information of the group account.

In block 407, an application service item list providing module provides at least one application service item list each includes a number of selectable application service items provided for the administrator to select.

In block 409, a register management module produces a register request including information of a group account of a user group and an application service item in response to an operation of selecting the application service item from the application service item list by the administrator of the user group. The register management module further sends the register request to an application service provider providing the selected application service item to register in the application service provider, and adds the selected application service item to the application cluster if registered in the application service provider successfully.

In the embodiment, the application service register management method can further include: a register management module produces a cancelling request for cancelling one application service item in response to an operation of cancelling the application service item on the application service item list, and sends the cancelling request to the corresponding application service provider to cause the application service provider to delete the information of the group account from the corresponding application service provider, and then deletes the application service item from the application cluster.

The application service register management method can further include: the creation module further creates at least one normal user account in responses to a creation operation of the administrator. The creation module creates the normal user account based on the group account of the user group that the administrator belongs to, the normal user account includes the information of the group account.

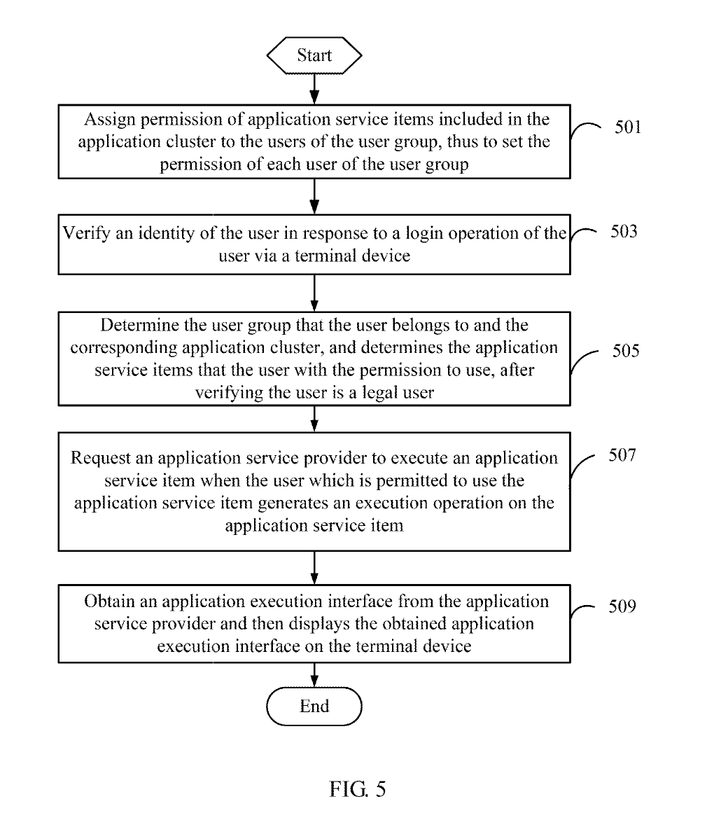

FIG. 5 is a flowchart diagram of an embodiment of the application assignment and execution method included in the application service management method.

In block 501, an assignment management module assigns permission of the application service items included in the application cluster to the users of the user group, thus to set the permission of each user of the user group.

In block 503, an login verification module verifies an identity of the user in response to a login operation of the user via a terminal device.

In block 505, when the login verification module verifies the user is a legal user, the login verification module further determines the user group that the user belongs to and the corresponding application cluster, and determines the application service items that the user with the permission to use.

In block 507, an execute control module requests the application service provider to execute an application service item when the user which is permitted to use the application service item generates an execution operation on the application service item.

In block 509, a display control module obtains an application execution interface from the application service provider and then displays the obtained application execution interface on the terminal device of the user.

The application assignment and execution method can further include: the assignment management module further disables the user to use an application service item in response to an operation of deleting the permission to use the application service item by the administrator.

The application assignment and execution method can further include: the display control module displays all of application service items that the user has the permission on the application cluster management interface when the user logs in the application cluster management interface, and displays corresponding description about the corresponding application service item in response to user operation.

In another embodiment, in the block 401, the creation request received by the request receiving module further includes an enterprise gateway address; in the block 403, the creation module further associates the enterprise gateway address with the group account and the identity of the user group. In the block 503, the login verification module further obtains the enterprise gateway address when the user logs in to the application cluster interface, and further verifies the identity of the user according to the enterprise gateway address. In detail, the login verification module obtains the group account from the user account and the enterprise gateway address when the user logs in via the user account, and judges whether the enterprise gateway address is corresponded to the group account, and verifies the user is a legal user when determining the enterprise gateway address is associated to the group account.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An application service management device configured to manage application service items of an application cluster, the application service management device comprising:
a communication unit configured to connect to at least one terminal device, each terminal device being belonged to a user of a user group;
a storage device configured to store a plurality of modules which are collection of instructions; and
at least one processor configured to execute the plurality of modules which are collection of instructions, the modules comprising:
an assignment management module configured to assign permission of the application service items comprised in the application cluster to the users of the user group, thus to set the permission of each user of the user group;
a login verification module configured to verify an identity of the user in response to a login operation of the user via a terminal device, and determine the user group that the user belonged to and the corresponding application cluster, and then determine the application service items that the user with the permission to use after verifying the user is a legal user;
an execute control module configured to request an application service provider to execute an application service item when the user which is permitted to use the application service item generates an execution operation on the application service item; and
a display control module configured to obtain an application execution interface from the application service provider and display the obtained application execution interface on the terminal device of the user.

2. The device according to claim 1, wherein the modules further comprise a creation module configured to provide an application cluster management interface, the application cluster management interface is provided for user to manage or use the application service item.

3. The device according to claim 2, wherein the modules further comprise a permission setting module configured to generate an administrator account according to the group account, the administrator account comprises information of the group account.

4. The device according to claim 3, wherein the creation module is further configured to create at least one normal user account in response to a creation operation of the administrator, wherein, the creation module creates the normal user account based on the group account of the user group that the administrator belonged to, the normal user account comprises the information of the group account.

5. The device according to claim 1, wherein the assignment management module is further configured to disable the user to use an application service item in response to an operation of deleting permission to use the application service item for the user.

6. An application service management method comprising:
assigning permission of the application service items comprised in an application cluster to the users of the user group, thus to set the permission of each user of the user group;
verifying an identity of the user in response to a login operation of the user via a terminal device, determining the user group that the user belonged to and the corresponding application cluster, and determining the application service items that the user with the permission to use after verifying the user is a legal user;
requesting an application service provider to execute an application service item when the user which is permitted to use the application service item generates an execution operation on the application service item; and
obtaining an application execution interface from the application service provider and displaying the obtained application execution interface on the terminal device of the user.

7. The method according to claim 6, further comprising:
providing an application cluster management interface, the application cluster management interface is provided for user to manage or use the application service item.

8. The method according to claim 7, further comprising:
generating an administrator account according to the group account, the administrator account comprises information of the group account.

9. The method according to claim 8, further comprising:
creating at least one normal user account in response to a creation operation of the administrator, wherein, the creation module creates the normal user account based on the group account of the user group that the administrator belonged to, the normal user account comprises the information of the group account.

10. The method according to claim 6, further comprising:
disabling the user to use an application service item in response to an operation of deleting permission to use the application service item for the user.

11. A non-transitory storage medium having stored thereon instructions that, when executed by at least one processor, causes the least one processor to execute instructions of a method for automatically managing application services, the method comprising:
assigning permission of the application service items comprised in an application cluster to the users of the user group, thus to set the permission of each user of the user group;
verifying an identity of the user in response to a login operation of the user via a terminal device, determining the user group that the user belonged to and the corresponding application cluster, and determining the application service items that the user with the permission to use after verifying the user is a legal user;
requesting an application service provider to execute an application service item when the user which is permitted to use the application service item generates an execution operation on the application service item; and
obtaining an application execution interface from the application service provider and displaying the obtained application execution interface on the terminal device of the user.

12. The non-transitory storage medium according to claim 11, further comprising:
providing an application cluster management interface, the application cluster management interface is provided for user to manage or use the application service item.

13. The non-transitory storage medium according to claim 12, further comprising:
generating an administrator account according to the group account, the administrator account comprises information of the group account.

14. The non-transitory storage medium according to claim 13, further comprising:
creating at least one normal user account in responses to a creation operation of the administrator, wherein, the creation module creates the normal user account based on the group account of the user group that the administrator belonged to, the normal user account comprises the information of the group account.

15. The non-transitory storage medium according to claim 11, further comprising:
disabling the user to use an application service item in response to an operation of deleting permission to use the application service item for the user.
